(19) United States
(12) Patent Application Publication
(10) Pub. No.: US 2019/0271669 A1
(43) Pub. Date: Sep. 5, 2019

(54) CHARACTERIZATION OF ULTRASONIC CONSOLIDATION BOND QUALITY

(71) Applicant: BATTELLE MEMORIAL INSTITUTE, Richland, WA (US)

(72) Inventors: Jonathan D. Suter, Richland, WA (US); Curtis J. Larimer, Richland, WA (US); Kayte M. Denslow, Richland, WA (US); Michael S. Hughes, Richland, WA (US); Wilaiwan Chouyyok, Richland, WA (US); Francesco Luzi, Kennewick, WA (US)

(73) Assignee: BATTELLE MEMORIAL INSTITUTE, Richland, WA (US)

(21) Appl. No.: 16/288,673

(22) Filed: Feb. 28, 2019

Related U.S. Application Data
(60) Provisional application No. 62/637,229, filed on Mar. 1, 2018.

(51) Int. Cl. G01N 29/44; B23K 20/10; G01N 29/12; G05B 19/401; G05B 19/406

(52) U.S. Cl. CPC G01N 29/4454; B23K 20/10; B23K 2101/36; G05B 19/401; G05B 19/406; G01N 29/12

(57) ABSTRACT

Methods, systems, and non-transitory computer-readable storage media having programs are described for monitoring an ultrasonic bonding operation via acoustic and/or vibration measurements and analyzing the measurements in order to predict and/or characterize the quality of a weld resulting from the bonding operation. The measurements are non-destructively acquired and the characterization is expressed as a bond quality index value.

### CROSS-REFERENCE TO RELATED APPLICATIONS

This invention claims priority from U.S. provisional patent application 62/637,229, entitled In-Situ Monitoring of an Ultrasonic, 3D Printing Process, filed Mar. 1, 2018. The application is incorporated by reference herein.

### ACKNOWLEDGEMENT OF GOVERNMENT SUPPORT

This invention was made with Government support under Contract DE-AC0576RL01830 awarded by the U.S. Department of Energy. The Government has certain rights in the invention.

### FIELD

The present disclosure relates to ultrasonic consolidation and more particularly to monitoring an ultrasonic welding process and characterizing resultant bonds.

### BACKGROUND

Ultrasonic consolidation (UC), or ultrasonic welding, is a promising subcategory of additive manufacturing (AM) that allows bonding of metal foils or sheets at relatively low temperature. UC utilizes sound waves and pressure to induce a solid-state bond between layers of metal foils. When combined with precision milling equipment UC can be used to build up 3D objects of solid metal into complex structures. UC bonds metals without causing excessive interfacial heating so the original material properties of stock foils can be maintained through the manufacturing process more easily than in selective laser sintering (SLS) methods.

One of the major industrial uses for ultrasonic welding is in the manufacture of lithium ion batteries because it can seal packages, bond tabs, and join wires without excessive heating. One difficulty often encountered is the inability to carefully control the ultrasonic welding process to ensure a reliable, high-quality bond. Unsuccessful ultrasonically welded bonds have been known to contribute to electrical shorts in lithium ion batteries, leading to expensive, hazardous, and very public product failures. Surprisingly, despite these past quality failures, the industry still does not have good methods to check the quality of an individual bond. The process parameters, material influences, and mechanical factors that result in high-quality UC metal components are difficult to predict or are poorly understood. The use of trial-and-error optimization during fabrication represents the chief hurdle between its current limited state of use and its potential to transform in widespread fashion the rapid prototyping and manufacturing of high-impact technologies. Accordingly, a need exists for methods, systems, and computer-readable storage media having programs for characterizing the quality of bonds created via ultrasonic bonding (i.e., UC).

### SUMMARY

Disclosed are method methods, systems, and non-transitory computer-readable storage media having programs for characterizing the quality of a bond resulting from an ultrasonic welding operation. The embodiments utilize non-destructive measurements and can be easily incorporated into new or existing ultrasonic consolidation systems.

In some embodiments, a method comprises the steps of sonically detecting vibration of workpieces throughout a duration of an ultrasonic weld operation performed by an ultrasonic bonding system, measuring a characteristic of the vibration of workpieces, and characterizing a result of the ultrasonic weld operation using a bond quality index based on the characteristic of the vibration, a change in the characteristic of the vibration, or both. The workpieces comprise metal.

In certain embodiments, said measuring, said characterizing, or both occur in an in-process mode or a post-process mode relative to the ultrasonic weld operation. In certain embodiments, the vibration of workpieces comprises emitted vibration from the workpieces and said detecting comprises detecting via an acoustic sensor. In certain embodiments, the acoustic sensor does not contact the workpieces. In certain embodiments, the acoustic sensor is positioned within a solid angle that is centered along an axis aligned with a direction of movement of a tool of the ultrasonic bonding system, the solid angle having a non-zero value less than 180 degrees, or less than or equal to 170 degrees, 160 degrees, 150 degrees, 130 degrees, 120 degrees, 90 degrees, 70 degrees, 60 degrees, 50 degrees, or 30 degrees. In certain embodiments, the vibration of workpieces comprises vibration transmitted through the workpieces. In certain embodiments, said detecting further comprises detecting via a transducer placed at an anvil of the ultrasonic bonding system. In certain embodiments, the characteristic of the vibration comprises non-linearity. In certain embodiments, the characteristic of the vibration comprises frequency. In certain embodiments, the workpieces comprise a battery tab, a current collector, a foil pouch, or a combination thereof.

In certain embodiments, the method further comprises modifying an operational parameter of the ultrasonic weld operation based on the bond quality index, the characteristic of the vibration, a change in the characteristic of the vibration, or a combination thereof. In certain embodiments, the operational parameter comprises bond pressure, bond time, bond vibration amplitude, or a combination thereof. In certain embodiments, the workpieces comprise dissimilar materials.

In certain embodiments, the method further comprises comparing at least a portion of the bond quality index, the vibration, the characteristic of the vibration, the changes in the characteristic of the vibration, or a combination thereof, to a dataset comprising vibration signatures each pre-correlated with bond assessments.

In some embodiments, a non-transitory, computer-readable storage medium stores one or more programs, the one or more programs comprise instructions, which are executable by one or more processors to sonically detect vibration of workpieces throughout a duration of an ultrasonic weld operation performed by an ultrasonic bonding system, measure a characteristic of the vibration of workpieces, and characterize a result of the ultrasonic weld operation using a bond quality index based on the characteristic of the vibration, a change in the characteristic of the vibration, or both.

In certain embodiments, the characteristic of the vibration comprises non-linearity. In certain embodiments, the characteristic of the vibration comprises frequency. In certain embodiments, the one or more programs further comprise instructions, which are executable by one or more processors to modify an operational parameter of the ultrasonic weld operation based on the bond quality index, the characteristic of the vibration, a change in the characteristic of the vibration, or a combination thereof. In certain embodiments, the operational parameter comprises bond pressure, bond time, bond vibration amplitude, or a combination thereof.

In some embodiments, a system comprises an ultrasonic bonding sub-system comprising a bonding tool and an anvil, an acoustic sensor positioned to detect emitted vibration from workpieces on the anvil, a transducer positioned at the anvil to detect transmitted vibration through the workpieces, or both configured to sonically detect vibration of the workpieces throughout a duration of an ultrasonic weld operation performed by the ultrasonic bonding sub-system, wherein the workpieces comprise a metal. The system further comprises a processor configured to measure a characteristic of the vibration of the workpieces and to characterize a result of the ultrasonic weld operation using a bond quality index based on the characteristic of the vibration, a change in the characteristic of the vibration, or both.

In certain embodiments, the characteristic of the vibration comprises non-linearity. In certain embodiments, the characteristic of the vibration comprises frequency. In certain embodiments, the acoustic sensor is positioned within a solid angle that is centered along an axis aligned with a direction of movement of a tool of the ultrasonic bonding system, the solid angle having a non-zero value less than 180 degrees, or less than or equal to 170 degrees, 160 degrees, 150 degrees, 130 degrees, 120 degrees, 90 degrees, 70 degrees, 60 degrees, 50 degrees, or 30 degrees. In certain embodiments, the processor is further configured to modify an operational parameter of the ultrasonic bonding sub-system based on the bond quality index, the characteristic of the vibration, a change in the characteristic of the vibration, or a combination thereof.

The purpose of the foregoing summary and the latter abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. Neither the summary nor the abstract is intended to define the invention of the application, which is measured by the claims, nor is it intended to be limiting as to the scope of the claims in any way.

### BRIEF DESCRIPTION OF THE DRAWINGS

FIGS. 1A and 1B are schematic illustrations of aspects of a system for characterizing bond quality resulting from an ultrasonic welding operation according to embodiments described herein.

FIGS. 2A and 2B are schematic illustrations of aspects of a computing system (2A) and data recording electronics (2B) according to embodiments described herein.

FIG. 3 includes a summary plot of mean weight change vs. normalized by total energy based on feature vector component three from table I), for all aluminum to aluminum welds according to microphone 0.

FIG. 4 includes a summary plot of mean weight change vs. normalized by total energy based on feature vector component three from table I), for all aluminum to brass welds according to microphone 4.

FIG. 5 includes a summary plot of mean weight change vs. normalized by total energy based on feature vector component three from table I), for all copper to copper welds according to microphone 3.

FIG. 6 includes a summary plot of mean weight change vs. normalized by total energy based on feature vector component six from table I), for all copper to copper welds according to microphone 3.

### DETAILED DESCRIPTION

Described herein are methods, systems, and non-transitory computer-readable storage media having programs for monitoring ultrasonic bonding operations via acoustic and/or vibration measurements and analyzing the measurements in order to predict and/or characterize the quality of a weld resulting from the bonding operation. One of the beneficial features of UC is the ability to bond dissimilar metals; embodiments described herein can provide quality characterizations for such dissimilar metals. For example, UC monitoring as described herein can be used with aluminum, copper, gold, iron, magnesium, molybdenum, nickel, platinum, silver, titanium, tungsten, related alloys, and more.

As used herein, workpieces comprise at least two pieces that are bonded together as a result of an ultrasonic weld operation. The workpieces can comprise metal and/or metal-containing material. The results of the weld operation can vary, ranging from a failed bond, to a mere softening or light adhering of one or more of the workpieces, to a true joining of the workpieces, to an over-bonded failed joining. Embodiments described herein can measure characteristics of the vibration of workpieces and can characterize the result of the operation using a bond quality index. The bond quality index can be flexibly designated based on the characteristics of the vibration of the workpieces and based on the commercial application. The value of the bond quality index can be discrete or continuous. For example, the index can comprise pass or fail values. Alternatively, the index can comprise “overwelded,” “strong,” “moderate,” or “weak” values. Further still, the index can comprise a continuous numeric value provided at a precision that meets the needs of the particular application.

The inventors determined that control and optimization of the UC process is difficult at least because there are many mutually dependent variables that can affect outcomes. To the inventors' knowledge, unfortunately, a robust model has not previously been developed to predict optimal ultrasonic parameters generalized for any given combination of materials and part geometries. Due to the complexity of AM via the UC process, and the variables involved with part quality, it has still been necessary to monitor and test each part. Robust in situ monitoring and nondestructive evaluation (NDE) are not well developed for AM. Few, if any, physics-based modeling currently exists to predict or support AM quality outcomes. The complex nature of some AM parts (i.e., free form lattice structures and parts with embedded features) means that traditional NDE methods are difficult to apply for many AM evaluations. It is an aim of the embodiments described herein to provide non-destructive process monitoring and/or evaluation of a UC process and the resultant weld. Examples of sources of variability can include, but are not limited to, instrument settings, instrument-specific problems, environmental issues, cleanliness, sample conditioning issues, and many others. While diligent adherence to best practices can reduce the impact of many of these sources of variability, an industrially applicable and very practical way of establishing quality assurance is to monitor the bonding process directly as described herein.

In certain embodiments, the monitoring can enable feedback and adjustments for the process. The characterization of the weld operation results based on measured characteristics of the vibration of workpieces can occur in-process (i.e., while the weld operation is being performed) or during post-process (i.e., after completion of the weld operation). In certain embodiments, feedback can be provided to the ultrasonic welding system according to the bond quality index value. The feedback can motivate adjustments to the operating parameters of the ultrasonic welding system.

Ultrasonic welding is typically based on generating a solid-state bond between two metals by applying moderate pressure and high intensity sound waves (20-70 kHz frequencies) at their interface. The process is highly nonlinear. During the solid-state process, surface contaminants are incorporated into the weld region. Hence, not only physical but chemical interactions play a significant role in bond formation, strength and durability. Unfortunately, the parameters necessary to ultrasonically join mixed materials are currently developed on a trial-and-error basis and have to be deduced each time a new metal material or material geometry is introduced or a new combination of metals is joined. This process limits how quickly the ultrasonic consolidation process can be optimized before proceeding with fabrication. Optimizing welding parameters so materials can be joined without “over-welding” is equally important as it minimizes material damage and also enables joining with delicate composites such as metallic foams. Thus, a key question tied to the broader application of this technique is, how can optimal ultrasonic joining parameters be predicted to allow for truly rapid ultrasonic consolidation prototyping? Development of dynamical models that identify the number of control variables and define their interactions places this prediction problem firmly in the realm of mathematical optimization and thus provides a concrete framework to both pose and solve this problem.

The inventors have determined that the relatively early stages of the welding process provide an opportunity for sensing abnormal process conditions. For example, the power required in this period changes depending on the level of surface contamination due to different friction conditions. These different power levels lead to different amounts of material deformation, resulting in changes in ultrasonic horn displacement. Thus, the energy, E(t), absorbed from the horn and the indentation depth, D(t), in early stages are two important signals. Unexpectedly, the results and embodiments described herein show that these are highly correlated with the acoustic field generated during the welding process. Therefore, the inventors discovered that measurements of the acoustic field can be used as surrogates for E(t) and D(t), and the features derived from them. Two such derived features are the energy at the mid-point of the welding process, E_{mid}, and the indentation depth at the mid-point of the welding process, D_{mid}, respectively. These have been shown to be strong predictors of weld quality and some examples of quantities (i.e., metrics) that generalize E_{mid} and D_{mid} are provide elsewhere herein.

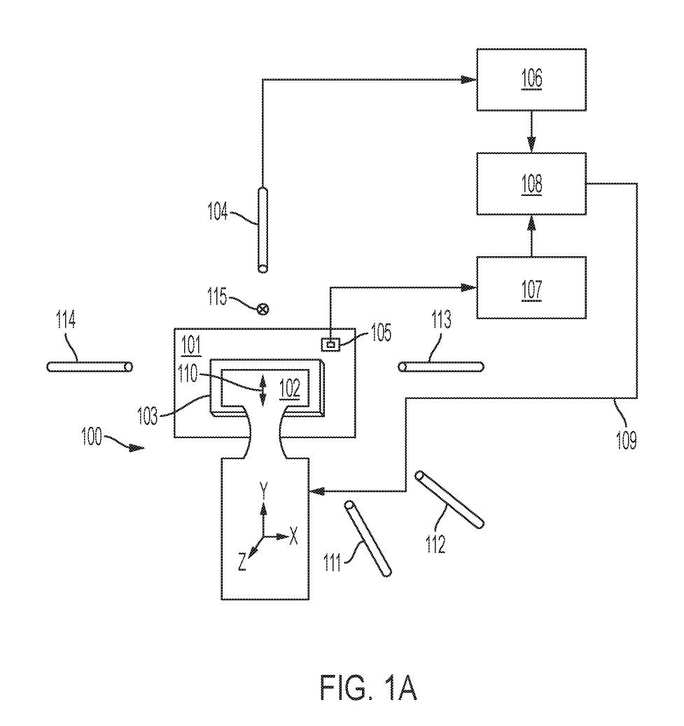

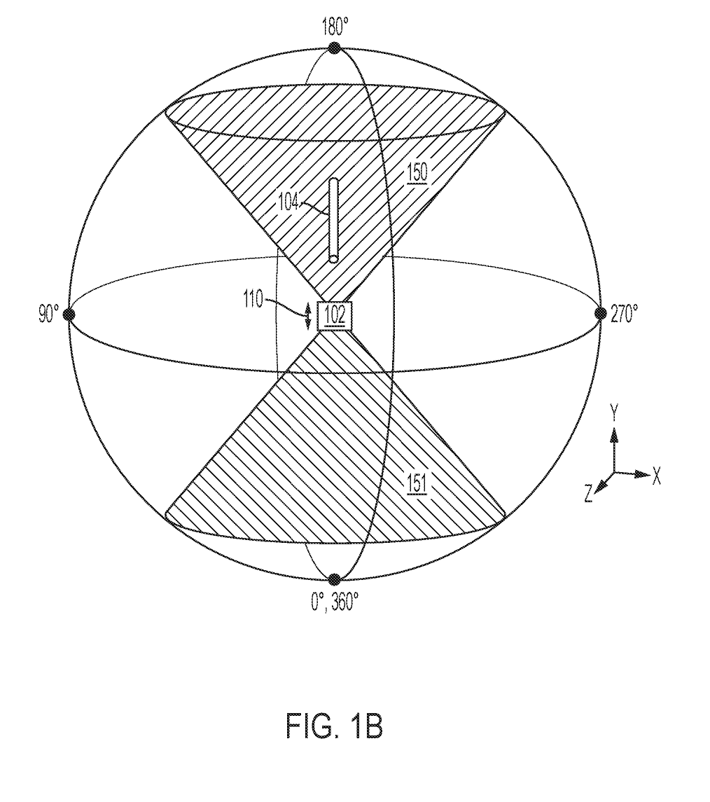

Referring to FIG. 1A, a schematic diagram of an ultrasonic welding system 100 includes an anvil 101 and a welding tool 102. The welding tool vibrates in a direction 110 parallel to the y-axis. Welding operations occur in the space between the tool and the anvil, where a workpiece 103 comprising metal foils can be placed. An acoustic sensor 104 is drawn as being positioned at an angle of 180 degrees from the tool. Alternative positions 114, 113, 112, and 111 are at approximately 90, 270, 325, and 330 degrees, respectively. Position 115 is normal to the X-Y plane. The acoustic sensor 114 is operably connected to a data recorder 108 that acquires acoustic measurements during the ultrasonic weld operation. A preamplifier can be optionally used between the sensor and the data recorder. In some embodiments, a transducer 105 can be placed at the anvil 101. The transducer is operably connected to a preamplifier 107 and the data recorder 108. The sensor and/or the transducer measures characteristics of the vibration of the workpieces imparted via the welding tool. The measurements can be analyzed in process (i.e. at the time of the weld operation) or post process (i.e., at a time after the weld operation has completed). Examples of characteristics of vibrations of the workpieces can include, but are not limited to frequency and amplitude of the vibrations. The frequency and amplitude measurements can be acquired as a function of time. In certain embodiments, the drive frequency and/or amplitude of the welding tool can be explicitly and intentionally disregarded. For example, data acquisition can occur through frequency and/or amplitude windows that exclude the drive parameters of the tool. Alternatively, the drive parameters can be filtered out of the acquired data. In certain embodiments, the characteristic of the vibration of the workpieces is not a vertical displacement of the welding tool 102. The characteristic of the vibration of the workpieces is based on workpiece response. In certain embodiments, analysis of data from the data recorder can yield a characterization of the bond quality, which can be utilized in a feedback connection 109 to modify an operational parameter of the ultrasonic welding system.

Referring to FIG. 1B, effective positions for acoustic sensor 104 placement occur within a solid angle 150, 151 centered on an axis aligned with the direction of movement 110 of the welding tool 102. The solid angle can be defined between 90 and 270 degrees 150 and/or between 270 and 90 degrees 151 in three dimensions. In other words, the solid angle can have a non-zero value less than 180 degrees and is centered on the axis aligned with the direction of tool movement. Alternatively, the solid angle can have a non-zero value less than 170, 160, 150, 130, 120, 90, 70, 60, 50, or 30 degrees. In certain embodiments, the microphones are not placed at 90 or 270 degrees.

The explanations of terms and abbreviations herein are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

Non-transitory as used herein when referring to a computer-accessible medium, is a limitation of the medium itself (i.e., tangible, not a propagating electromagnetic signal) as opposed to a limitation on data storage persistency. The term is not intended to otherwise limit the type of physical computer-readable storage device that is encompassed by the phrase computer-accessible medium or memory. For instance, the terms “non-transitory computer readable medium” or “tangible memory” are intended to encompass types of storage devices that do not necessarily store information permanently, including but not limited to, computer-readable media that store data only for short periods of time and/or only in the presence of power, such as register memory, processor cache and Random Access Memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

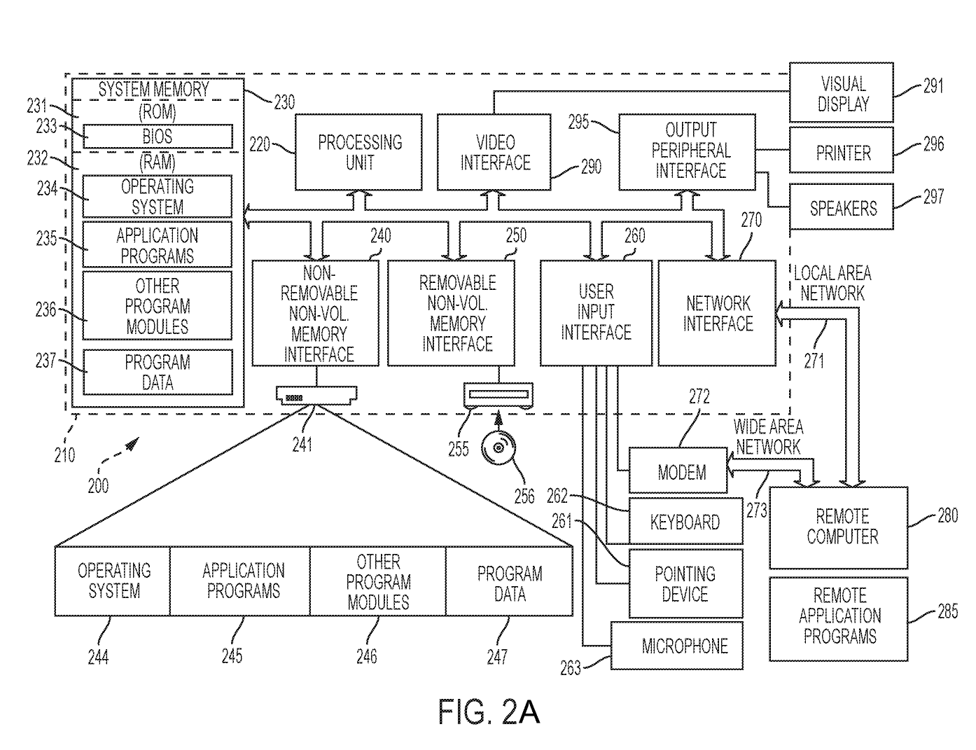

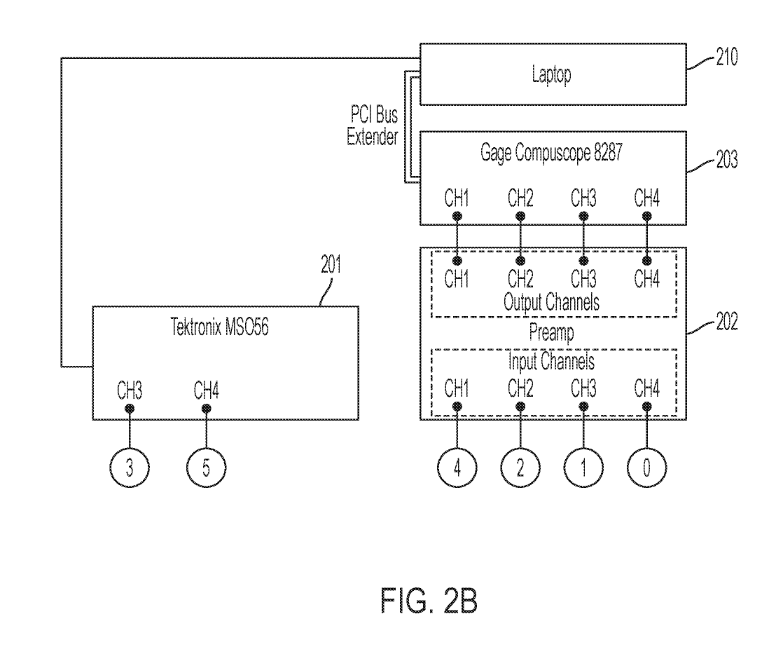

FIG. 2A is one embodiment of a computing environment to which acoustic sensors, transducers, and/or ultrasonic welding systems can be operably connected. Alternatively, the computing environment can be integrated with an ultrasonic welding system having sensors and/or transducers. In one example, a computing environment such as shown in FIG. 2 can be used to perform measurements of vibrations of workpieces and analysis of the measurements. The computing environment can further be used to characterize the results of ultrasonic weld operations using bond quality indices. The computing environment can further be used to provide feedback to the ultrasonic welding system based on the bond quality index and to modify operational parameters of the welding system.

With reference to FIG. 2A, an example system for implementing some embodiments includes a general-purpose computing device in the form of a computer 210. Components of computer 210 may include, but are not limited to, a processing unit 220 (which is not limited to CPUs, but can comprise GPUs), a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described herein be deployed in corresponding portions of FIG. 2.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, sash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 210. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 230 includes computer storage media in the form of volatile and/or nonvolatile memory such as read only memory (ROM) 231 and random-access memory (RAM) 232. A basic input/output system 233 (BIOS), containing the basic routines that help to transfer information between elements within computer 210, such as during startup, is typically stored in ROM 231. RAM 232 typically contains data and/or program modules that are immediately accessible to and/or presently being operated on by processing unit 220. By way of example, and not limitation, FIG. 2A illustrates operating system 234, application programs 235, other program modules 236, and program data 237.

The computer 210 may also include other removable/nonremovable volatile/nonvolatile computer storage media. By way of example only, FIG. 2A illustrates a hard disk drive 241 that reads from or writes to non-removable, nonvolatile magnetic media, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, sash memory cards, digital versatile disks, digital video tape, solid state RAM, solid state ROM, and the like. The hard disk drive 241 is typically connected to the system bus 221 through a nonremovable memory interface such as interface 240, and optical disk drive 255 are typically connected to the system bus 221 by a removable memory interface, such as interface 250.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 2A, provide storage of computer readable instructions, data structures, program modules and other data for the computer 210. In FIG. 2A, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies.

A user may enter commands and information into the computer 210 through input devices such as a keyboard 262, a microphone 263, and a pointing device 261, such as a mouse, trackball or touch pad. Other input devices (not shown) may include a joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A visual display 291 or other type of display device is also connected to the system bus 221 via an interface, such as a video interface 290. Video interface 290 can comprise a graphics card having a GPU. The GPU be used for computations. In addition to the monitor, computers may also include other peripheral output devices such as speakers 297 and printer 296, which may be connected through an output peripheral interface 295.

The computer 210 is operated in a networked environment using logical connections to one or more remote computers, such as a remote computer 280. The remote computer 280 may be a personal computer, a hand-held device, a server, a router, a network PC, a peer device or other common network node, and typically includes many or all of the elements described above relative to the computer 210. The logical connections depicted in FIG. 2A include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2A illustrates remote application programs 285 as residing on remote computer 280. It will be appreciated that the network connections shown are exemplary and other means of establishing a communications link between the computers may be used.

Referring to FIG. 2B, a schematic diagram illustrates different embodiments in which microphones are can be operably connected to a pre-amplifier 202 and a data recorder (i.e., digitizer) 203 or can be operably connected directly to a data recorder 201. The data recorders can be operably connected to a computer (e.g., laptop 210) like that shown in FIG. 2A. FIG. 2B as illustrated shows that microphones 0 (111), 1 (112), 2 (113), and 4 (114) are connected to channels 4, 3, 2, and 1, respectively of the preamplifier. Microphones 3 (104) and 5 (115) are connected to channels 3 and 4 of a data recorder, respectively.

### EXAMPLES AND COMPARISONS

To further illustrate certain embodiments of the disclosed methods, systems, and non-transitory, computer-readable storage media for monitoring ultrasonic weld processes and characterizing resultant welds, and to provide various comparative analyses and data, below are some examples with comparison test data. Described herein are classifications of ultrasonic weld quality based on acoustic emissions generated during a joining process for similar metals: aluminum to aluminum and copper to copper, as well as differing materials: aluminum to brass. A Sonics® model MWB20 ultrasonic spot welder with integral base was used to produce all ultrasonic welds used in these examples. Referring to FIG. 1A, the spot welder head (i.e., tool) 102 vibrates in a direction 110 parallel to the y-axis as illustrated. The active region of the spot welder is located on the bottom side of the tool above the anvil 101. The spot weld area is specified by the system manufacturer to be 80.65 mm². Welding times and power levels were performed by adjusting the range preset amplitudes to range from 25 to 65 μm in 5 μm increments.

Six microphones were used as acoustic sensors for acquisition of acoustic signatures produced during ultrasonic welding operations. Acoustic signatures comprise features of recorded sound waves that may be defined by frequency, amplitude, or some other property computed from recorded and digitized acoustic data. An accelerometer (i.e., a piezoelectric sensor) was mounted on the welder base (i.e., anvil) as an additional source of data. Four microphones were connected to a pre-amplifier and a data recorder comprising a Gage Compuscope 8287. Two microphones were connected directly to a data recorder comprising a Textronix MSO56. A total of six different acoustic signatures were acquired during each weld (i.e., one signature per microphone). The locations of the microphones are shown in FIG. 1 and occur at approximately 90°, 180°, 270°, 325°, and 330° relative to an axis aligned with the direction of movement of the ultrasonic weld tool (see FIGS. 1A and 1B). Zero degrees is designated as the center of the tool. Acoustic emissions recorded during ultrasonic weld operations were digitized at 12-bit resolution, and a sampling rate of either 6.25 or 10 MHz. The drive frequency of the tool and associated harmonic frequencies, while present in the acoustic recordings, were not explicitly monitored or used to calculate acoustic signatures. The drive frequency was observed during each experience and was found to be stable around 20 kHz. A Fourier analysis was used to determine that acoustic signals apart from the drive frequency and associated harmonics were present in the recorded acoustic data. In certain embodiments the frequency components associated with the drive frequency are removed prior to analysis. In practice, it was not necessary to filter drive frequency out because it could effectively be ignored as a consistent background term.

Quantities to be used for characterization of bond quality were computed from digital records comprising measurements of characteristics of the vibration of the workpieces. Eight quantities were determined based on the energy of the waveform, or its mean value, and were normalized to total energy. Each of these eight quantities were designed to quantify non-linearity in the acoustic data. Non-linearity in acoustics is a physical phenomenon of sound waves of sufficiently large amplitudes. Sound waves propagating through a medium induce a localized pressure change. When the amplitude of these waves is large, the local temperature is increased in areas of high pressure, which modifies the local speed of sound. This results in sound waves being distorted as they travel. The eight calculated quantities measure different types of distortion from the expected mixture of sinusoidal standing waves and, in some cases, normalize them against the signal's total energy. Eleven information-theoretic quantities were determined based on Renyi entropy. Entropies quantify the diversity, uncertainty, and/or randomness of a system. As an example, the Renyi entropy can be used as an index of diversity (i.e., how many different types or sources there are in the data and the distribution of types). These quantities were computed by analyzing the complete acoustic recordings captured during 1-second-long welds. In all cases at least one of these quantities served as a bond quality index and was able to classify welds into two discrete classes corresponding to acceptable or unacceptable welds with perfect sensitivity (true positive rate) and specificity (true negative rate). These quantities can be used individually or can be used together, as components of a feature vector. Welds were determined to be either acceptable or unacceptable based on measurements of the welded samples after destructive pull testing. Acceptable welds resulted in strong adhesion, causing mechanical failure and transfer of mass between workpieces instead of delamination. By measuring the weight of the workpieces before and after welding and pull-testing it was possible to calculate the decimal fraction of mass transfer in the weld area of the workpieces. A value of 0.2 was empirically determined to be a good threshold to discriminate acceptable and unacceptable welds.

A program based on embodiments described herein was written to analyze digitized data that were recorded during ultrasonic welds to produce 19 different quantities; all intended for use individually or as components in a feature vector for evaluation of different classifiers of weld quality (i.e., bond quality indices). These are summarized in Table I and can be considered as falling into one of two categories. Physical-based quantities comprise measures of nonlinearity (estimated from the asymmetry of the acoustic wave about the zero axis), mean value, or total energy. The first eight components are essentially energy based although different normalizations are used. Information-theoretic quantities can comprise Renyi entropies where order a=0.1, 0.2, 0.3, 0.4, 0.5, 1.0, 1.5, 1.6, 1.7, 1.8, or 1.9. For a=1, which corresponds to component 14, Shannon's entropy is obtained. These eleven quantities are information-theoretic in nature. Previous studies have shown that these are often more sensitive the changes in acoustic signature than are energy-based components. In some embodiments, the quantities can be used to produce a high dimensional feature vector with highly uncorrelated components. Components 5 and 9, based on the Renyi entropy metric with a=0.1, provide good examples of weld-quality discrimination. The metrics, once selected were used to classify bond quality with a binary index (acceptable or not) or an index with multiple levels (e.g., “low-strength”, “intermediate-strength”, and “higher-strength”). The metrics are simple to calculate and do not require a significant computational burden. As such, they can be calculated repeatedly during the process of a weld (e.g., many times per second) using data that is collected in real time and immediately included in subsequent calculations. Early in the weld process the metric will indicate that a strong or acceptable bond has not been achieved. However, at the point at which the bond occurs, or the period over which the bond occurs, the value of the metric will shift to indicate that the bond has completed. By calculating the metric or metric during the process they can be used to estimate when it is safe to terminate the bond without jeopardizing bond strength. This has the added benefit of ensuring that the bond will not be overwelded. Judging the correct time to abort a weld will have significant benefits to the users of ultrasonic welding equipment. Ultrasonic welding tools wear over time owing to the fact that they are repeatedly pressed against metal workpieces and vibrated with high amplitude. Over time, the wear on an ultrasonic welding tool reduces its effectiveness until it has to be replaced. Many users of ultrasonic welding equipment routinely overweld the parts they are joining. That is, more energy is imparted to workpieces than is strictly necessary to join them. This excess energy is particularly deleterious to the welding tool because wear is highest when vibrating against a solid (bonded) workpiece. Using the methods and systems disclosed herein, users of ultrasonic welding equipment will be able to calculate metrics that indicate bond quality in real time and thus only impart the energy that is strictly necessary to complete the bond.

TABLE I
A summary of some metrics that can be applied
individually or combined as a feature component vector
for characterizing bond quality.

| | Information- | Feature Vector |
|---|---|---|
| Physical | Theoretic | Component |
| ∫₀¹f(t)dt | — | 1 |
| ∫₀¹\|f(t)\|dt | — | 2 |
| ∫₀¹f(t)²dt | — | 3 |
| $\vert \frac{{\int }_{0}^{1} f ( t ) dt}{{\int }_{0}^{1} \vert f ( t ) \vert dt} \vert$ | — | 4 |
| $\vert \frac{{\int }_{0}^{1} f ( t ) dt}{{\int }_{0}^{1} {f ( t )}^{2} dt} \vert$ | — | 5 |
| \|∫₀¹[(f(t)⁺)² − (f(t)⁻)²]dt\| | — | 6 |
| $\vert \frac{{\int }_{0}^{1} [ {( {f ( t )}^{+} )}^{2} - {( {f ( t )}^{-} )}^{2} ] dt}{{\int }_{0}^{1} \vert f ( t ) \vert dt} \vert$ | — | 7 |
| $\vert \frac{{\int }_{0}^{1} [ {( {f ( t )}^{+} )}^{2} - {( {f ( t )}^{-} )}^{2} ] dt}{{\int }_{0}^{1} {f ( t )}^{2} dt} \vert$ | — | 8 |
| — | $\frac{1}{1 - α} \sum {p}_{i}^{α}$ | 9-19 |

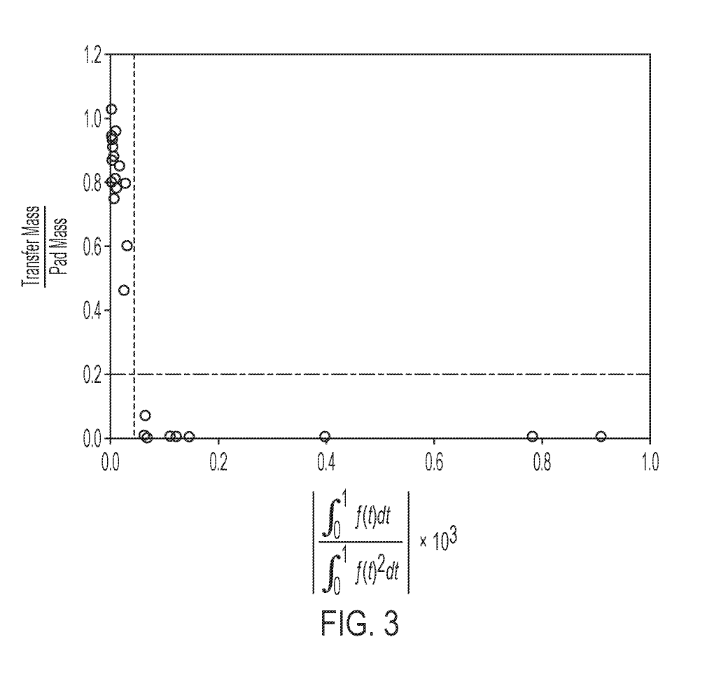

Referring to FIG. 3, a summary plot of mean weight change plotted against the integrated and normalized acoustic energy (i.e., feature vector component 5 from table I), for all aluminum to aluminum welds based on data from microphone 0. Each data point in this figure represents the calculated values for a single welded aluminum test piece. The vertical axis on FIG. 3 indicates weld quality, calculated by weighing test pieces before and after welding and destructive testing. A higher value on this axis is indicative of larger fractional mass transfer which means that the weld was strong. Low mass transfer would have indicated that the workpieces delaminated and little or no bond was formed between them. When a metric can assess the quality of a weld we expected data to cluster into distinct groupings that have some correlation to, or are separable by, the feature vector values on the x-axes. FIG. 3 shows an example of this grouping. The horizontal line shows a cutoff between acceptable (above of the horizontal line) and unacceptable (below of the horizontal line) welds at 0.2, and the vertical line shows a good threshold for the calculated metric using the feature vector component. That is, setting a threshold (between 0 and 0.2) for this feature vector component will be able to divide the welds into acceptable and not acceptable categories. This threshold was identified automatically using statistical software and yields very good results, with zero false positives and zero false negatives. Depending on the industrial application, the proxy for weld quality can be qualified. Once qualified, data such as those shown above could be used to produce a bone fide receiver operator curve. In other words, a threshold for the metric can be established that results in the lowest possible rate of false positive (false good) results and the lowest possible rate of false negative results (false bad).

TABLE II
A summary of results for all metal weld pairs and all acoustic channels for
feature vector component five (“FG” is false good, and “FB” is false bad).

| Materials | Microphone 0 | Microphone 1 | Microphone 2 | Microphone 3 | Microphone 4 | Microphone 5 |
|---|---|---|---|---|---|---|
| Al/Al | (0 FG, 0 FB) | (2 FG, 0 FB) | (2 FG, 0 FB) | (1 FG, 1 FB) | (3 FG, 0 FB) | (0 FG, 0 FB) |
| Al/Brass | (4 FG, 0 FB) | (2 FG, 0 FB) | (3 FG, 0 FB) | (4 FG, 1 FB) | (1 FG, 0 FB) | (2 FG, 0 FB) |
| Al/Cu | NA | NA | NA | NA | NA | NA |
| Al/Ni | NA | NA | NA | NA | NA | NA |
| Brass/Brass | NA | NA | NA | NA | NA | NA |
| Cu/Cu | No | No | No | (0 FG, 0 FB) | (0 FG, 0 FB) | No |
| Ni/Ni | NA | NA | NA | NA | NA | NA |

Table II presents a summary of results for all metal weld pairs and all acoustic channels for feature vector component five, which exhibited very high sensitivity or specificity for Al/Al, Al/Brass and Cu/Cu welds. The Renyi entropies (shown below) also cluster weld strengths into three groups and have good sensitivity.

TABLE III
A summary of results for all metal weld pairs and all acoustic channels for feature vector component nine.

| Materials | Microphone 0 | Microphone 1 | Microphone 2 | Microphone 3 | Microphone 4 | Microphone 5 |
|---|---|---|---|---|---|---|
| Al/Al | No | No | No | No | No | No |
| Al/Brass | No | No | No | No | No | No |
| Al/Cu | NA | NA | NA | NA | NA | NA |
| Al/Ni | NA | NA | NA | NA | NA | NA |
| Brass/Brass | NA | NA | NA | NA | NA | NA |
| Cu/Cu | No | No | No | (0 FG, 0 FB) | (0 FG, 0 FB) | (0 FG, 0 FB) |
| Ni/Ni | NA | NA | NA | NA | NA | NA |

A summary of results for all metal weld pairs and all acoustic microphones (i.e., channels) for feature vector component nine, which exhibited very high sensitivity or specificity for Al/Al, Al/Brass or Cu/Cu welds. The following conventions are used in Tables III and IV.
FG: False good weld, also referred to as a false positive (FP).
FB: False bad weld, also referred to as a false negative (FN).
NA: insufficient data, primarily all bad (e.g., Al/Cu) or all good (e.g., Cu/Cu) welds, or data set is too small as in the case of Ni/Ni.
   Al/Cu all welds are bad
   Al/Ni all but four welds are bad
   Brass/Brass all but 2 welds are bad
   Ni/Ni cohort too small
No: no trends depending on component 5 (Table II) or 9 (Table III)

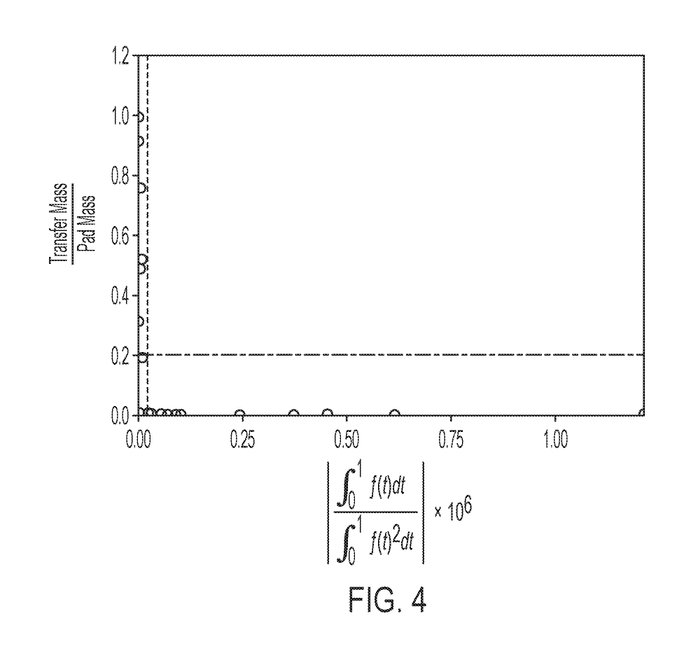

Referring to FIG. 4, a summary plot of mean weight change vs. integrated and normalized acoustic energy (i.e., feature vector component 5 from table I), for all aluminum to brass welds based on microphone 4. The vertical axis is a proxy for a good weld. The horizontal line shows a cutoff between acceptable (left of the vertical blue line) and unacceptable (right of the vertical line) welds. Using this cutoff there is only one false positive and zero false negatives. Depending on the industrial application, the proxy for weld quality can be qualified. Once qualified, data such as those shown above could be used to produce a bone fide receiver operator curve.

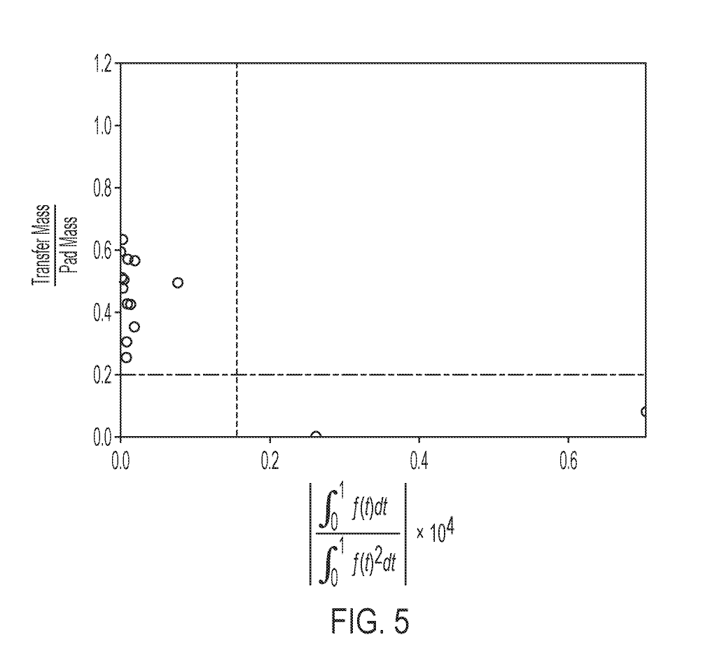

Referring to FIG. 5, a summary plot of mean weight change vs. integrated and normalized acoustic energy 5 from table I), for all copper to copper welds based on microphone 3. The vertical axis is a proxy for a good weld. The horizontal line shows a cutoff between acceptable (left of the vertical blue line) and unacceptable (right of the vertical line) welds. Using this cutoff there are zero false positives and zero false negatives. Depending on the industrial application, the proxy for weld quality can be qualified. Once qualified, data such as those shown above could be used to produce a bone fide receiver operator curve.

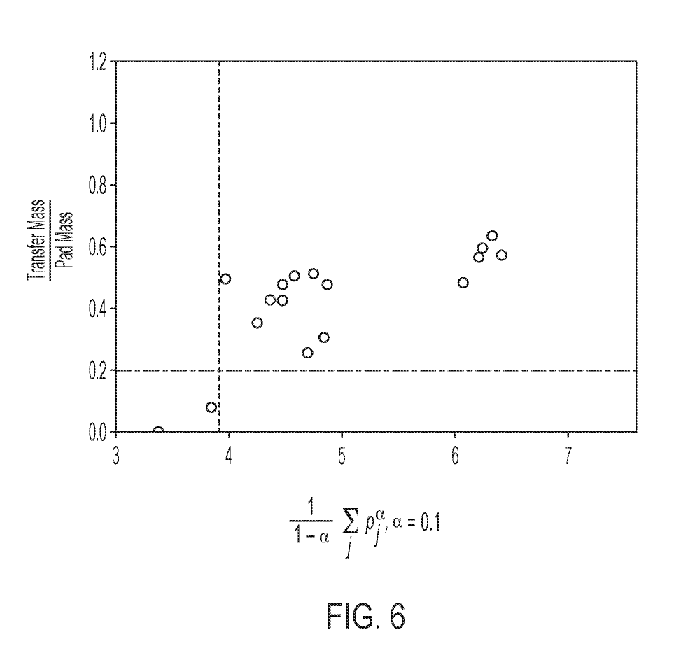

Referring to FIG. 6, a summary plot of mean weight change vs. the Renyi entropy parameter of order a=0.1 (i.e., feature vector component 9 from Table I), for all copper to copper welds based on microphone 3. The vertical axis is a proxy for a good weld. The horizontal line shows a cutoff between acceptable (right of the vertical line) and unacceptable (left of the vertical line) welds. Using this cutoff there are zero false positives and zero false negatives. Depending on the industrial application, the proxy for weld quality can be qualified. Once qualified, data such as those shown above could be used to produce a bone fide receiver operator curve. Observe that unlike the data using feature component five shown in FIG. 5, the Renyi entropy of order a=0.1 can separate the welds into three groups: “low-strength”, “intermediate-strength”, and “higher-strength”.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

What is claimed is:

1. A method comprising the steps of:
sonically detecting vibration of workpieces throughout a duration of an ultrasonic weld operation performed by an ultrasonic bonding system, wherein the workpieces comprise a metal;
measuring a characteristic of the vibration of workpieces; and
characterizing a result of the ultrasonic weld operation using a bond quality index based on the characteristic of the vibration, a change in the characteristic of the vibration, or both.

2. The method of claim 1, wherein said measuring, said characterizing, or both occur in an in-process mode or a post-process mode relative to the ultrasonic weld operation.

3. The method of claim 1, wherein the vibration of workpieces comprises emitted vibration from the workpieces and said detecting comprises detecting via an acoustic sensor.

4. The method of claim 3, wherein the acoustic sensor does not contact the workpieces.

5. The method of claim 3, wherein the acoustic sensor is positioned within a solid angle that is centered along an axis aligned with a direction of movement of a tool of the ultrasonic bonding system, the solid angle having a non-zero value less than 180 degrees, or less than or equal to 170 degrees, 160 degrees, 150 degrees, 130 degrees, 120 degrees, 90 degrees, 70 degrees, 60 degrees, 50 degrees, or 30 degrees.

6. The method of claim 1, wherein the vibration of workpieces comprises vibration transmitted through the workpieces.

7. The method of claim 6, wherein said detecting further comprises detecting via a transducer placed at an anvil of the ultrasonic bonding system.

8. The method of claim 1, wherein the characteristic of the vibration comprises non-linearity.

9. The method of claim 1, wherein the characteristic of the vibration comprises frequency.

10. The method of claim 1, wherein the workpieces comprise a battery tab, a current collector, a foil pouch, or a combination thereof.

11. The method of claim 1, further comprising modifying an operational parameter of the ultrasonic weld operation based on the bond quality index, the characteristic of the vibration, a change in the characteristic of the vibration, or a combination thereof.

12. The method of claim 11, wherein the operational parameter comprises bond pressure, bond time, bond vibration amplitude, or a combination thereof.

13. The method of claim 1, wherein the workpieces comprise dissimilar materials.

14. The method of claim 1, further comprising comparing at least a portion of the bond quality index, the vibration, the characteristic of the vibration, the changes in the characteristic of the vibration, or a combination thereof, to a dataset comprising vibration signatures each pre-correlated with bond assessments.

15. A non-transitory, computer-readable storage medium storing one or more programs, the one or more programs comprising instructions, which are executable by one or more processors to:
sonically detect vibration of workpieces throughout a duration of an ultrasonic weld operation performed by an ultrasonic bonding system, wherein the workpieces comprise a metal;
measure a characteristic of the vibration of workpieces; and
characterize a result of the ultrasonic weld operation using a bond quality index based on the characteristic of the vibration, a change in the characteristic of the vibration, or both.

16. The non-transitory, computer-readable storage medium of claim 15, wherein the characteristic of the vibration comprises non-linearity.

17. The non-transitory, computer-readable storage medium of claim 15, wherein the characteristic of the vibration comprises frequency.

18. The non-transitory, computer-readable storage medium of claim 15, storing one or more programs, the one or more programs further comprising instructions, which are executable by one or more processors to modify an operational parameter of the ultrasonic weld operation based on the bond quality index, the characteristic of the vibration, a change in the characteristic of the vibration, or a combination thereof.

19. The non-transitory, computer-readable storage medium of claim 18, wherein the operational parameter comprises bond pressure, bond time, bond vibration amplitude, or a combination thereof.

20. A system comprising:
An ultrasonic bonding sub-system comprising a bonding tool and an anvil;
An acoustic sensor positioned to detect emitted vibration from workpieces on the anvil, a transducer positioned at the anvil to detect transmitted vibration through the workpieces, or both configured to sonically detect vibration of the workpieces throughout a duration of an ultrasonic weld operation performed by the ultrasonic bonding sub-system,
wherein the workpieces comprise a metal; and
A processor configured to measure a characteristic of the vibration of the workpieces and to characterize a result of the ultrasonic weld operation using a bond quality index based on the characteristic of the vibration, a change in the characteristic of the vibration, or both.

21. The system of claim 20, wherein the characteristic of the vibration comprises non-linearity.

22. The system of claim 20, wherein the characteristic of the vibration comprises frequency.

23. The system of claim 20, wherein the acoustic sensor is positioned within a solid angle that is centered along an axis aligned with a direction of movement of a tool of the ultrasonic bonding system, the solid angle having a non-zero value less than 180 degrees, or less than or equal to 170 degrees, 160 degrees, 150 degrees, 130 degrees, 120 degrees, 90 degrees, 70 degrees, 60 degrees, 50 degrees, or 30 degrees.

24. The system of claim 20, wherein the processor is further configured to modify an operational parameter of the ultrasonic bonding sub-system based on the bond quality index, the characteristic of the vibration, a change in the characteristic of the vibration, or a combination thereof.
